(19) United States
(12) Patent Application Publication
(10) Pub. No.: US 2010/0031459 A1
(43) Pub. Date: Feb. 11, 2010

(54) Automatic Vehicle Washing Apparatus Wash Brush Assembly

(76) Inventor: Edward Holbus, Racine, WI (US)

Correspondence Address: QUARLES & BRADY LLP, 411 E. WISCONSIN AVENUE, SUITE 2040, MILWAUKEE, WI, 53202-4497, US

(21) Appl. No.: 12/534,472

(22) Filed: Aug. 3, 2009

Related U.S. Application Data
(60) Provisional application No. 61/086,349, filed on Aug. 5, 2008.

(51) Int. Cl. B60S 3/00

(52) U.S. Cl. 15/97.3

(57) ABSTRACT

An automatic vehicle washing apparatus wash brush assembly includes a drive shaft having a longitudinal shaft axis. At least two disks extend radially relative to the shaft axis and are spaced along the shaft axis. One of the disks has a first through hole spaced radially from the shaft axis. The through hole is formed substantially parallel to the shaft axis and is aligned with a corresponding hole formed in a second disk adjacent the one of the disks. A rod extending through the through holes is fixed relative to the shaft axis. The rod extends through a loop fixed to a wash strip to fix the wash strip relative to the shaft axis.

### CROSS REFERENCES TO RELATED APPLICATIONS

This application claims the priority benefit of U.S. Provisional Patent Application No. 61/086,349 filed on Aug. 5, 2008, the entirety of which is fully incorporated herein by reference.

### STATEMENT REGARDING FEDERALLY SPONSORED RESEARCH

Not Applicable.

### FIELD OF INVENTION

This invention relates to an automatic vehicle washing apparatus, and particularly to a wash brush suitable for use in an apparatus for automatically washing the exterior of an automobile or other similar vehicles.

### BACKGROUND OF INVENTION

Automatic vehicle washing apparatus are well known. The apparatus typically takes one of two generic forms. In one form, an automobile is moved by a conveyor through successive stations at which various washing operations take place, such as wetting, scrubbing and rinsing. The second approach is to automatically perform these same operations upon a stationary vehicle. The present invention is adaptable to both forms of washing apparatus.

Brushes in known automatic vehicle washing apparatus include elongated wash strips formed of a flexible fabric material, such as cotton, synthetic resin, and the like, having one end fixed to a rotating shaft. The shaft is rotated to impinge the opposing end of the wash strips against the vehicle. As the wash strip engages the vehicle, dirt and grime are scrubbed off of the vehicle exterior surface.

Affixing the wash strips to the shaft is difficult. In one known method, one end of a strip is affixed to a rigid strip of material, such as metal or plastic, that is received in a longitudinal slot formed in the shaft. Affixing the strip to the rigid strip of material is time consuming and expensive. Moreover, slipping the rigid strip of material into the slot formed in the shaft is also time consuming and difficult. In addition, after extended use, the rigid strip of material can work its way out of the slot rendering the wash strip useless. Therefore, a need exists for a brush assembly suitable for use in an automatic vehicle washing apparatus in which wash strips are easily and securely affixed.

### SUMMARY OF THE INVENTION

The present invention provides an automatic vehicle washing apparatus wash brush assembly including a drive shaft having a longitudinal shaft axis. At least two disks extend radially relative to the shaft axis and are spaced along the shaft axis. One of the disks has a first through hole spaced radially from the shaft axis. The through hole is formed substantially parallel to the shaft axis and is aligned with a corresponding hole formed in a second disk adjacent the one of the disks. A rod extending through the through holes is fixed relative to the shaft axis. The rod extends through a loop fixed to a wash strip to fix the wash strip relative to the shaft axis.

A general objective of the present invention is to provide an automatic vehicle washing apparatus wash brush assembly on which wash strips can be easily fixed. This objective is accomplished in by providing an automatic vehicle washing apparatus wash brush assembly having rods that extend through a loop fixed to a wash strip to fix the wash strip relative to the shaft axis of the wash brush assembly.

The foregoing and other objects and advantages of the invention will appear from the following detailed description. In the description, reference is made to the accompanying drawings which illustrate a preferred embodiment of the invention.

### BRIEF DESCRIPTION OF THE DRAWINGS

FIG. 1 is an end view of a vehicle wash apparatus in accordance with the present invention;

FIG. 2 is a perspective view of the brush assembly of FIG. 1 partially disassembled;

FIG. 3 is perspective view of the shaft assembly of FIG. 2; and

FIG. 4 is a perspective view of the substrate/wash strip affixed to the shaft assembly of FIG. 3;

FIG. 5 is a perspective view of the substrate/wash strip of FIG. 2; and

FIG. 6 is an alternate embodiment of the wash strip affixed to the shaft assembly of FIG. 2.

### DETAILED DESCRIPTION OF THE PREFERRED EMBODIMENT

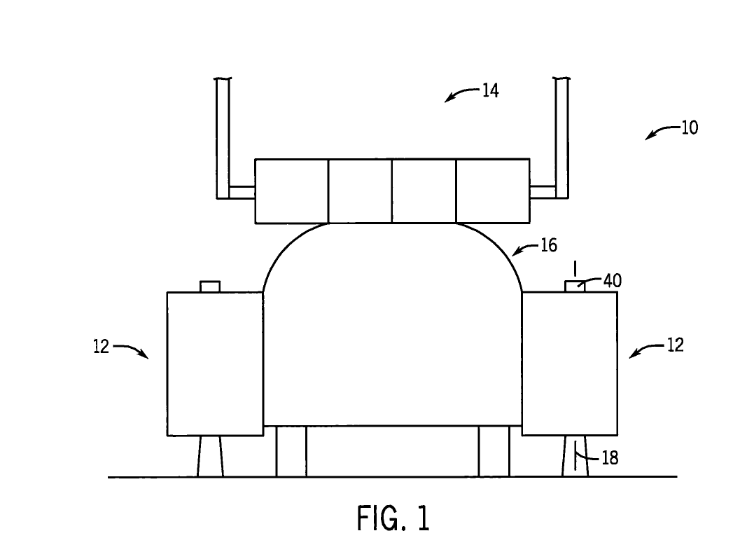

Referring to FIG. 1, an automatic vehicle washing apparatus 10 includes wash brushes 12, 14 that scrub a vehicle 16, such as a car, truck, and the like, moving past each brush 12, 14 along a vehicle path. Water is sprayed onto the vehicle 16, and in cooperation with the brushes 12, 14, dislodges and rinses away dirt and grime on the vehicle 16. In FIG. 1, two rotating side brushes 12 and a single rotating top brush 14 are shown. However, any number and combination of brushes having a rotating, reciprocating, or static action can be used without departing from the scope of the present invention. Moreover, the vehicle 16 can be stationary and the brushes 12, 14 can be moved relative to the vehicle 16 without departing from the scope of the invention.

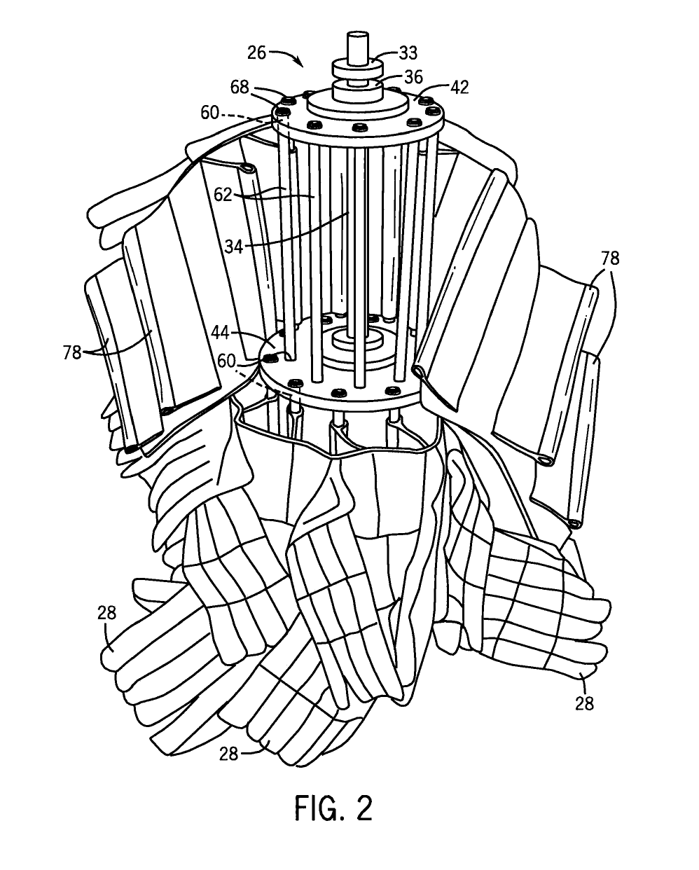

The brushes 12, 14 are substantially identical. Accordingly, only one of the side brushes 12 will be described with the understanding that the description applies to the other side brush 12 and top brush 14. As shown in FIGS. 2-4, the side brush 12 is an assembly including a vertically extending rotating shaft assembly 26 mounted adjacent to the vehicle path. Upon rotation of the brushes 12, 14, centrifugal forces urge wash strips 28 affixed to the shaft assembly 26 radially outwardly away from the shaft assembly 26 toward the vehicle 16 being washed.

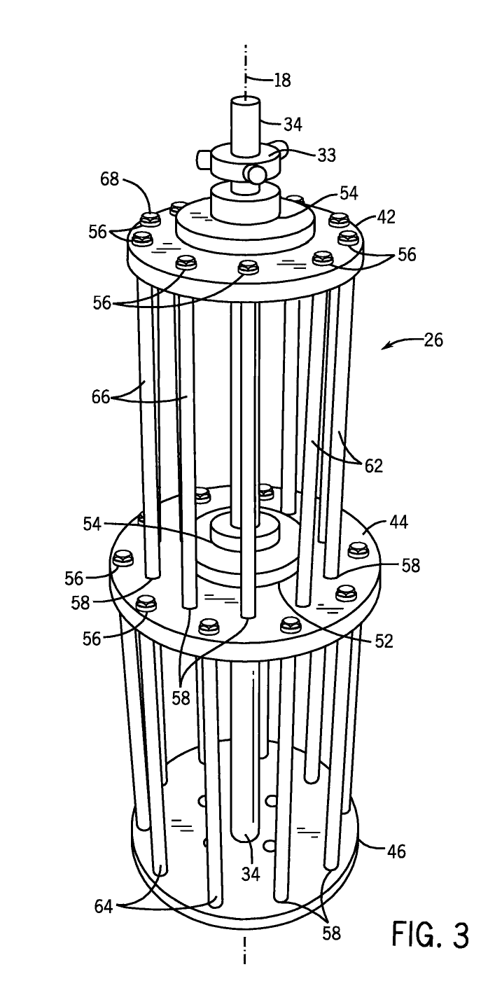

As shown in FIGS. 2 and 3, the shaft assembly 26 includes a center drive shaft 34 having a longitudinal shaft axis 18 defining an axis of rotation. In a preferred embodiment, one end 36 of the center drive shaft 34 includes a chuck 38 for coupling to a motor 40 (shown in FIG. 1) which rotatably drives the center drive shaft 34, and thus the shaft assembly 26. Of course, the center drive shaft 34 can be rotated using other methods known in the art, such as belt driven, chain driven, gear driven, direct drive, and the like.

The center drive shaft 34 supports disks 42, 44, 46 radially extending from the shaft axis 18 and spaced along the shaft length. Preferably, each disk 42, 44, 46 is mounted to the center drive shaft 34 using methods known in the art, such as clamping, welding, bolts, clips, and the like. Preferably, each disk 42, 44, 46 is formed from a plastic material, such as UHMW, fixed to a metal hub 52, such as by bolts or other fasteners, which is fixed to the center drive shaft 34. Although disks 42, 44, 46, such as shown in FIGS. 2-6, having a circular periphery are preferred to minimize material costs and balance the mass rotating about the shaft axis, the disks can have any shape, such as geometric shape, iconic shape, or free form, without departing from the scope of the invention.

Referring to FIG. 3, each disk 42, 44, 46 includes a center aperture 54 through which the center drive shaft 34 extends. A plurality of through holes 56 radially spaced from the longitudinal shaft axis 18 are formed through one of the disks 42. The through holes 56 are aligned with a like number of through holes 58 formed through the adjacent disk 44, i.e. each through hole 56 in one disk 42 is axially aligned with the corresponding through hole 58 formed through the adjacent disk 44. Each pair of aligned through holes 56, 58 receives a rod 62 for affixing the wash strips 28 thereto. Although a center aperture 54 formed through each disk 42, 44, 46 is preferred to accommodate a center drive shaft 34 extending the length of the brush, the center aperture 54 can be omitted in one or more of the disks 42, 44, 46, and other means for transmitting torque along the length of the brush can be provided, such as through individual shafts extending between the disks, through the rods 62 forming offset shafts, and the like, without departing from the scope of the invention.

In the embodiment disclosed in FIGS. 2 and 3, the center drive shaft 34 supports three disks, an upper disk 42, an intermediate disk 44, and a lower disk 46. The through holes 56 formed through the upper disk 42 are aligned with a first set of through holes 58 formed through the intermediate disk 44. Likewise, through holes 64 formed through the lower disk 46 are aligned with a second set of through holes 66 formed through the intermediate disk 44. The first and second sets of through holes 58, 66 formed through the intermediate disk 44 are radially offset to maximize the number of through holes that can receive the rods 62 extending between the intermediate disk 44 and the upper and lower disks 42, 46. Of course, the first and second sets of through holes can be substantially the same distance radially from the shaft axis 18 without departing from the scope of the invention with the understanding that the number of attachment points, i.e. rods 62, for the wash strips 28 may be reduced compared to providing radially offset sets of through holes. Other methods of retaining the rods axially relative to the disks can be used, such as clamps, clips, pins, and the like without departing from the scope of the invention.

Each rod 62 is removably received in the aligned through holes to simplify affixing the wash strips 28 to the shaft assembly 26. As shown in FIG. 3, each rod 62 has a circular cross section to avoid sharp edges that can damage the wash strip 28 affixed thereto. Preferably, each rod 62 has opposing threaded ends 60 that threadably engage threaded nuts 68 to fix the rod 62 relative to the disks 42, 44, 46. Advantageously, removing one of the nuts 68 from one of the rod ends 60 allows the rod to be easily removed from the disks 42, 44, 46 for mounting a wash strip 28 thereto. In an alternate embodiment, the rods are retained in the through holes by a removable cap plate fixed to each disk 42, 44, 46 proximal the rod ends to prevent the rods from slipping through the through holes receiving the rod ends. The removable cap plate can cover one or more through holes without departing from the scope of the invention.

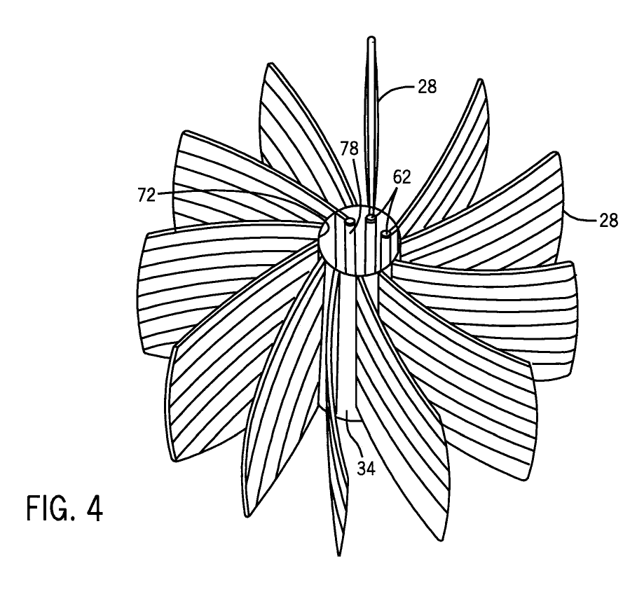

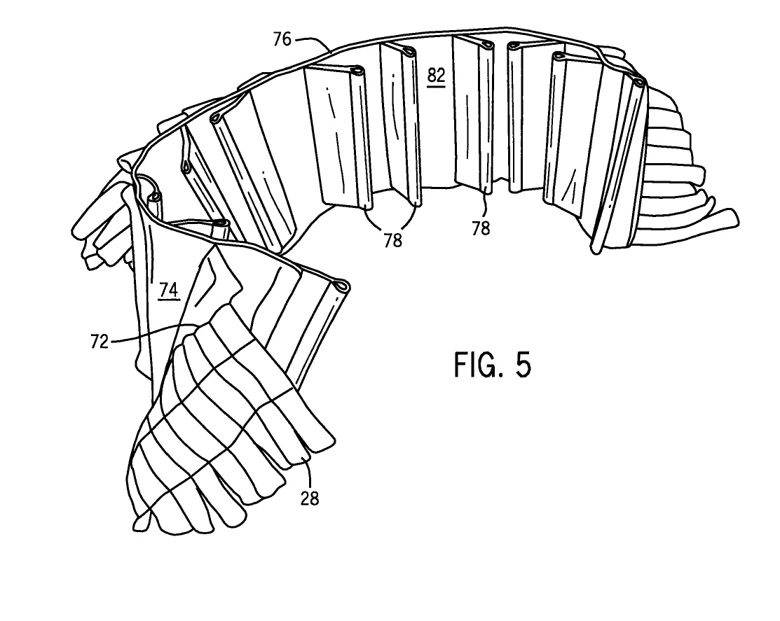

The wash strips 28 are fixed to the shaft assembly 26 using loops 78 wrapped around the rods 62. In one embodiment shown in FIGS. 4 and 5, a distal end 72 of each wash strips 28 is fixed to an outwardly facing side 74 of a substrate 76. Loops 78 fixed to an opposing, inwardly facing side 82 of the substrate 76 wrap around the rods 62 to secure the wash strips 28 relative to the shaft axis 18. In one embodiment, the substrate 76 is formed from a non-stretching flexible material, such as a polyester vinyl material, with the loops 78 formed from the same material is sewn onto the outwardly facing side 74 of the substrate 76. The substrate 76 can be formed from any material that can radially support the loops 78 and wash strips 28, such as a composite material, rubber, cotton, foam, and the like, without departing from the scope of the material. Most preferably, each wash strip 28 includes a cover enclosing a sponge, such as described in U.S. Pat. No. 6,795,996, which is fully incorporated herein by reference. Advantageously, the sponge absorbs water that is expelled to dislodge and remove dirt and grime on the cover.

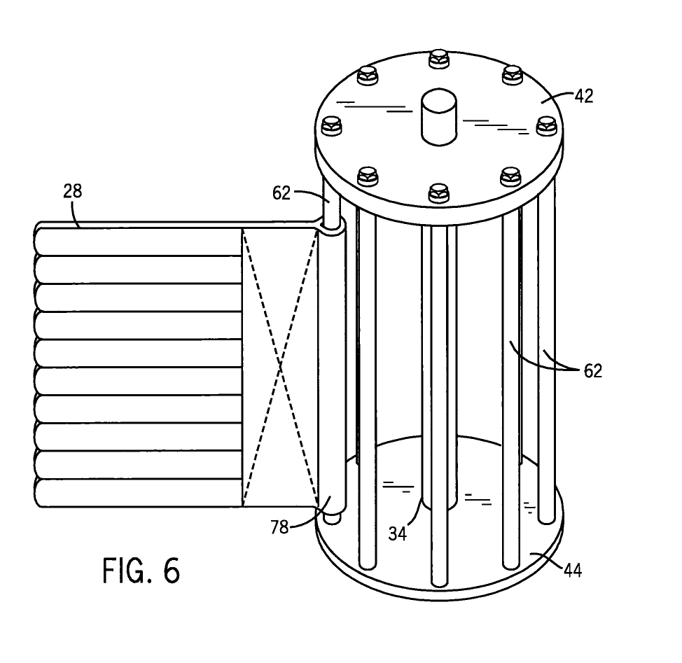

The wash strips 28 extend radially outwardly from the substrate 76, and can be formed from any flexible material known in the art for washing a vehicle, such a microfiber fabric, cotton, foam, nylon, polyester, and the like. Of course, the wash strips 28 can also be formed using one or more flexible materials without departing from the scope of the invention. In an alternate embodiment shown in FIG. 6, each wash strip 28 includes an individual loop 78 forming a distal end of the wash strip 28. As in the embodiment shown in FIGS. 4-6, each loop 78 wraps around one of the rods 62 to affix the wash strip 28 to the shaft assembly 26. Advantageously, the embodiment shown in FIG. 7 eliminates the need for the substrate 76.

Referring back to the embodiment shown in FIGS. 2-5, the wash strips 28 are affixed to the shaft assembly 26 by removing one of the nuts 68 from one of the ends 60 of each rod 62 and slipping the rod 62 through the through hole 56, 58, 66 of one of the disks 42, 44, 46 to expose a free end of the rod 62. The free end of each rod is then slipped through one of the loops 78 of the wash strips 28 to fix the wash strip 28 relative to the shaft axis 18. The rod free end is then slipped back through the through hole 56, 58, 66 of one of the disks 42, 44, 46 and the nut 68 is threadably engaged with the rod free end to secure the rod 62 relative to the shaft axis 18.

While there has been shown and described what are at present considered the preferred embodiments of the invention, it will be obvious to those skilled in the art that various changes and modifications can be made therein without departing from the scope of the invention defined by the appended claims. For example, the rods can have a non-circular cross section, such as a multi-sided geometric shape, oval, teardrop, and the like, without departing from the scope of the invention.

I claim:

1. An automatic vehicle washing apparatus wash brush assembly comprising:
a drive shaft having a longitudinal shaft axis;
at least two axially spaced disks extending radially relative to said shaft axis and fixed relative to said drive shaft, one of said disks having a first through hole spaced radially from said shaft axis, said first through hole being formed substantially parallel to said shaft axis and aligned with a corresponding hole formed in a second disk adjacent said one of said disks;
a rod extending through said through holes and being removably relative to said shaft axis; and
a wash strip fixed to a loop, said rod extending through said loop to fix said wash strip relative to said shaft axis.

2. The automatic vehicle washing apparatus wash brush assembly as in claim 1, in which said drive shaft extends through a center aperture formed in one of said disks, and said shaft supports said disk.

3. The automatic vehicle washing apparatus wash brush assembly as in claim 2, in which a hub joins said one of said disks to said drive shaft.

4. The automatic vehicle washing apparatus wash brush assembly as in claim 1, in which said wash strip is fixed to one side of a substrate and said loop is fixed to an opposite side of said substrate.

5. The automatic vehicle washing apparatus wash brush assembly as in claim 4, in which a plurality of wash strips are fixed to said one side of said substrate and a plurality of loop are fixed to said opposite side of said substrate, and at least some of said plurality of loops receive a rod therethrough to fix said wash strips relative to said shaft axis.

6. The automatic vehicle washing apparatus wash brush assembly as in claim 1, in which said loop is fixed to one end of said wash strip.

7. The automatic vehicle washing apparatus wash brush assembly as in claim 1, in which one of said disks includes a second through hole spaced radially inwardly from said first through hole, said second through hole being aligned with a third through hole formed through third disk, said second through hole and said third through hole receiving a rod therethrough.

8. The automatic vehicle washing apparatus wash brush assembly as in claim 1, in which at least one of said disks has a circular periphery.

9. The automatic vehicle washing apparatus wash brush assembly as in claim 1, in which said rod has a circular cross section.

10. An automatic vehicle washing apparatus wash brush assembly comprising:
a drive shaft having a longitudinal shaft axis;
a first disk fixed relative to said drive shaft, said first disk having a first through hole spaced radially from said shaft axis;
a second disk spaced axially from said first disk and fixed relative to said drive shaft, said second disk having a second through hole spaced radially from said shaft axis;
a third disk interposed between said first and second disk, said third disk having a third through hole aligned with said first through hole in said first disk, said third disk further having a fourth through hole aligned with said second through hole in said second disk;
a first rod extending between said first through hole and said third through hole;
a second rod extending between said second through hole and said fourth through hole;
a first wash strip fixed to a loop wrapping around said first rod; and
a second wash strip fixed to a loop wrapping around said second rod.

11. The automatic vehicle washing apparatus wash brush assembly as in claim 10, in which said third through hole is radially spaced from said fourth through hole.

12. The automatic vehicle washing apparatus wash brush assembly as in claim 10, in which said drive shaft extends through a center aperture formed in one of said first and second disks.

13. The automatic vehicle washing apparatus wash brush assembly as in claim 12, in which a hub joins said one of said first and second disks to said drive shaft.

14. The automatic vehicle washing apparatus wash brush assembly as in claim 10, in which one of said first and second wash strips is fixed to one side of a substrate and said loop is fixed to an opposite side of said substrate.

15. The automatic vehicle washing apparatus wash brush assembly as in claim 14, in which a plurality of first wash strips are fixed to said one side of said substrate and a plurality of loops are fixed to said opposite side of said substrate, and at least some of said plurality of loops receive first rods therethrough to fix said first wash strips relative to said shaft axis.

16. The automatic vehicle washing apparatus wash brush assembly as in claim 10, in which said loop of said first wash strip is fixed to one end of said first wash strip.

17. The automatic vehicle washing apparatus wash brush assembly as in claim 10, in which at least one of said first, second, and third disks has a circular periphery.

18. The automatic vehicle washing apparatus wash brush assembly as in claim 10, in which at least one of said first and second rods has a circular cross section.
